(19) United States
(12) Patent Application Publication
(10) Pub. No.: US 2021/0107650 A1
(43) Pub. Date: Apr. 15, 2021

(54) AERIAL FIREFIGHTING SYSTEM

(71) Applicant: Mike Elias Bandak, Rancho Cucamonga, CA (US)

(72) Inventor: Mike Elias Bandak, Rancho Cucamonga, CA (US)

(21) Appl. No.: 16/653,685

(22) Filed: Oct. 15, 2019

(51) Int. Cl. B64D 1/16; B64D 47/00; A62C 31/00

(52) U.S. Cl. CPC B64D 1/16; A62C 31/005; B64D 47/00

(57) ABSTRACT

An aerial firefighting system (AFS) is provided that is more effective and produced at lower cost than existing firefighting systems currently in operation. The AFS may use at least one wing mounted tank having an interior volume and attached to at least one of aircraft wings, the volume of the tank is adapted to hold a fire retardant and includes a nozzle in fluid communication with the volume. The wing mounted tanks are modified with a controllable flow nozzle at the end of each firefighting tank to ensure correct coverage and pinpoint accuracy of aerial drops. An auxiliary tank held within the cargo hold (feed cargo tank) is in fluid communication with the wing mounted tanks. The auxiliary tank may be a palletized tank that can be loaded on to the plane as needed. The auxiliary tank may hold between 4000-5000 gallons so as to allow an aerial tanker to make additional drops without having to land for additional fire retardant liquids.

### FIELD OF THE INVENTION

The present invention in general relates to firefighting, and in particular to an aerial firefighting system for deploying fire retardant chemicals or water in a fire zone.

### BACKGROUND OF THE INVENTION

Aerial firefighting is the use of aircraft and other aerial resources to combat wildfires by dispersing fire retardant chemicals or water from the aircraft on to the area being consumed by fire. Water is usually dropped directly on flames because its effect is short-lived. Fire retardants are typically dropped ahead of the moving fire or along its edge and may remain effective for two or more days. This can create artificial firebreaks where the terrain is too rugged or remote for ground crews to cut fireline. The types of aircraft used include fixed-wing aircraft and helicopters. Chemicals used to fight fires may include water, water enhancers such as foams and gels, and specially formulated fire retardants. In recent years fire retardant chemicals that are safer for the environment have been deployed that use ammonium sulfate or ammonium polyphosphate with attapulgite clay thickener or diammonium phosphate with a guar gum derivative thickener.

Airtankers or water bombers are fixed-wing aircraft fitted with tanks that can be filled on the ground at an air tanker base or, in the case of flying boats and amphibious aircraft, by skimming water from lakes, reservoirs, or large rivers. The largest fixed wing airtankers are converted passenger or cargo planes, the largest of which is the Boeing 747 that can carry up to 19,600 gallons fed by a pressurized drop system. A common military airplane and its variants which has been in use since 1956 and has been converted for use in firefighting is the Lockheed C-130 Hercules. The C-130 Hercules is a four-engine turboprop aircraft that is capable of using unprepared runways for takeoffs and landings. In a firefighting role up to 3500 gallons of water or fire retardant chemicals can be deployed using the C-130. A non-exhaustive list of other conventional fixed wing air lift aircraft capable of and/or have been used for carrying the high weight payloads needed for fire fighting include the Antonov An-12 Cub and An-32, Beriev Be-200, Ilyushin 11-76, Boeing 737, McDonnell Douglas DC-10, Martin Mars, Lockheed P-3 Orion, Lockheed P-2 Neptune, Douglas DC-6, Douglas DC-7, Bombardier CL-215, CL-415, and Dash 8, Grumman S-2T, and the Shaanxi Y-9.

While there are many aerial firefighting delivery systems there continues to be a need for more effective fixed wing delivery systems produced at a lower cost with a higher fire retardant capacity.

### SUMMARY OF THE INVENTION

An aerial firefighting system (AFS) is provided with at least one wing mounted tank having an interior volume and attached to at least one of aircraft wings, the volume of the tank is adapted to hold a fire retardant and includes a nozzle in fluid communication with the volume. The wing mounted tanks may be converted range extending fuel tanks. The wing mounted tanks have a valve controllable flow nozzle for dispersal of the fire retardant dry chemical, fire retardant fluid, or water. The valve is controlled by the flight crew using at least one actuator motor to control flow rate, nozzle direction, valve pulsing, or a combination thereof. The wing mounted tanks each have a pylon with an optional quick connect system for attachment and detachment of the wing mounted tank from the aircraft wing. The AFS system may further include an auxiliary tank held within a cargo hold of the aircraft, the auxiliary tank in fluid communication with the wing mounted tanks. The auxiliary tank may be a palletized tank that can be loaded on to the aircraft as needed. An external firefighting tank may also be mounted as a pod to the under belly of an aircraft.

A kit that coverts an aircraft into an aerial firefighting system (AFS) is provided that includes components to retrofit a wing tank to include a nozzle, a valve assembly, and a sensor array. The valve assembly includes the valve and at least one actuator motor therefor. The actuator motor under the control of the flight crew within the aircraft. The sensor array communicating sensor data to the flight crew that includes at least one of flowrate, nozzle angle, or valve pulsing. The wing mounted tanks may be converted range extending fuel tanks. The wing mounted tanks have a controllable flow nozzle for dispersal of the fire retardant chemical, fluid, or water. The wing mounted tanks each have a pylon with a quick connect system for attachment and detachment of the wing mounted tank from the aircraft wing. The conversion kit for the AFS system may further include an auxiliary tank held within a cargo hold of the aircraft, the auxiliary tank in fluid communication with the wing mounted tanks. The auxiliary tank may be a palletized tank that can be loaded on to the aircraft as needed. The conversion kit is transportable or shippable to remote areas.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a side perspective view of an aircraft outfitted with a conversion kit to a firefighting aircraft in accordance with embodiments of the invention;

FIG. 2 illustrates a side perspective view of an aircraft of FIG. 1 with a rear cargo bay door in a down position for loading an auxiliary tank in accordance with embodiments of the invention;

FIG. 3 is an exploded view of the firefighting aircraft of FIG. 1 showing the wing mounted tanks in greater detail, as well as the feed system from the auxiliary tank to the wing mounted tanks in accordance with embodiments of the invention;

FIG. 4 is a cutaway side view showing the auxiliary tank loaded in the cargo bay of the aircraft of FIG. 1 in accordance with embodiments of the invention;

FIG. 5A is a photograph of the auxiliary tank in accordance with embodiments of the invention;

FIG. 5B is a photograph of the auxiliary tank being loaded into the cargo bay of the aircraft of FIG. 1 in accordance with embodiments of the invention

FIG. 5C is a photograph of the auxiliary tank loaded in the cargo bay of the aircraft of FIG. 1 in accordance with embodiments of the invention;

FIG. 5D is a photograph of a multi-cell auxiliary tank being loaded in the cargo bay of the aircraft of FIG. 1 in accordance with embodiments of the invention;

FIG. 6 is a detail view of a shutoff valve used in the firefighting system in accordance with embodiments of the invention;

FIG. 7 illustrates a detailed view one of the wing mounted tanks showing a discharge nozzle with a shutoff valve and a nozzle pivot control in accordance with embodiments of the invention;

FIG. 8 illustrates a cut away view of a prior art pylon quick connect that may be configured to secure a wing mounted tanks to the aircraft wing;

FIG. 9 is a photograph of a belly mounted auxiliary tank as part of an aerial firefighting system (AFS) in accordance with embodiments of the invention; and

FIG. 10 illustrates the aircraft of FIG. 1 executing a drop of fire retardant over a forest fire.

### DETAILED DESCRIPTION OF THE INVENTION

The present invention has utility as an aerial firefighting system (AFS) that is more effective and produced at lower cost than existing firefighting systems currently in operation. Embodiments of the invention may use two or more wing-mounted converted range extending fuel tanks for holding fire retardant dry chemicals, fire retardant fluid, or water. The wing mounted tanks are modified with a controllable flow nozzle at the end of each firefighting tank to ensure correct coverage and accuracy of aerial drops. In a specific inventive embodiment, an auxiliary tank held within the cargo hold or otherwise within the fuselage (feed cargo tank) is in fluid communication with the wing mounted tanks. The auxiliary fuselage tank may be a palletized tank that can be loaded on to the plane as needed. The auxiliary tank may hold between 4000-5000 gallons (˜15,000-19,000 liters) so as to allow an aerial tanker to make additional drops without having to land for additional fire retardant.

Cost efficiencies are realized with embodiments of the present invention as the wing mounted tanks and palletized auxiliary tank are made by modifying existing parts. Embodiments of the invention allow for an easy and quick conversion of an aircraft to operation as a firefighting tanker, as well as the reconversion of the aircraft to an original configuration. The conversion of an aircraft does not require permanent modification to the aircraft, and is a cheaper solution for converting a standard aircraft to a firefighting tanker. The components required to convert a standard aircraft to a firefighting aircraft may be sold or leased as a kit. The conversion kit may be easy and convenient to store when not in use, and is readily transportable or shippable to remote areas

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

While the accompanying drawings depicts a C-130 aircraft, it is appreciated that the present invention is equally applicable to other air lift transport aircraft such as the aforementioned An-12 and Shaanxi Y-9 and others in the non-exhaustive list. In specific inventive embodiments, a one drop capacity with two wing mounted tanks is 2700 gallons (˜10,000 liters) of firefighting materials of dry chemicals, fluids, or water that may be augmented from an auxiliary tank held within the cargo hold (feed cargo tank) with a further capacity of 4000-5000 gallons (˜15,000-19,000 liters). Flow rates may be adjustable. In a specific embodiment the flow rate may be 1550 gallons (˜5,900 liters) per second with a complete load being jettisoned in approximately one second. In a specific inventive embodiment, a tanker has the capability of making six (6) drops with one wing tank before expending firefighting chemical, or three (3) drops with two wing tanks before expending firefighting chemical and then landing for replenishment. Embodiments of the inventive firefighter tanker affords better dispersion and retardant delivery control than conventional firefighting tankers.

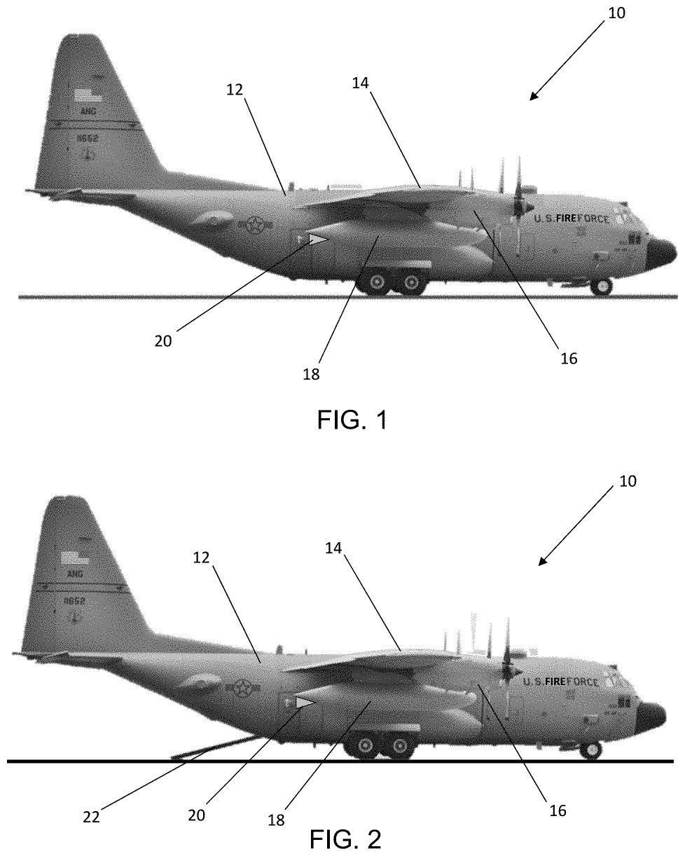

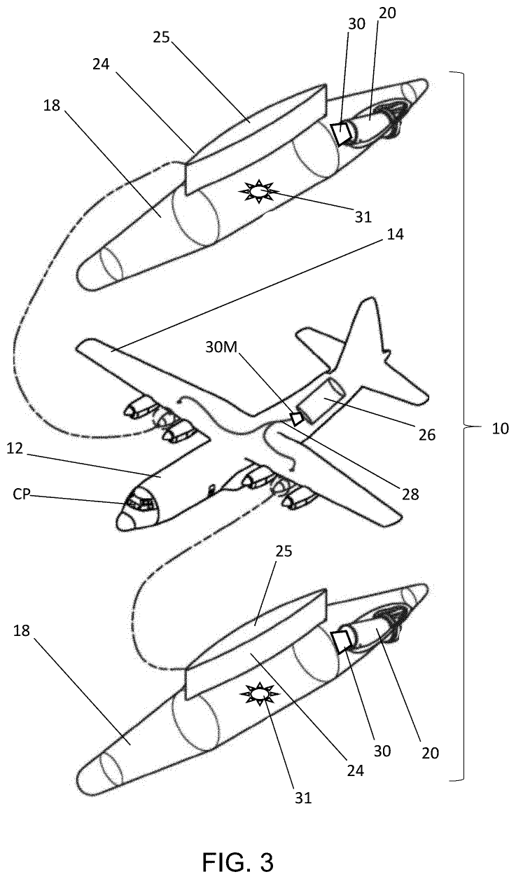

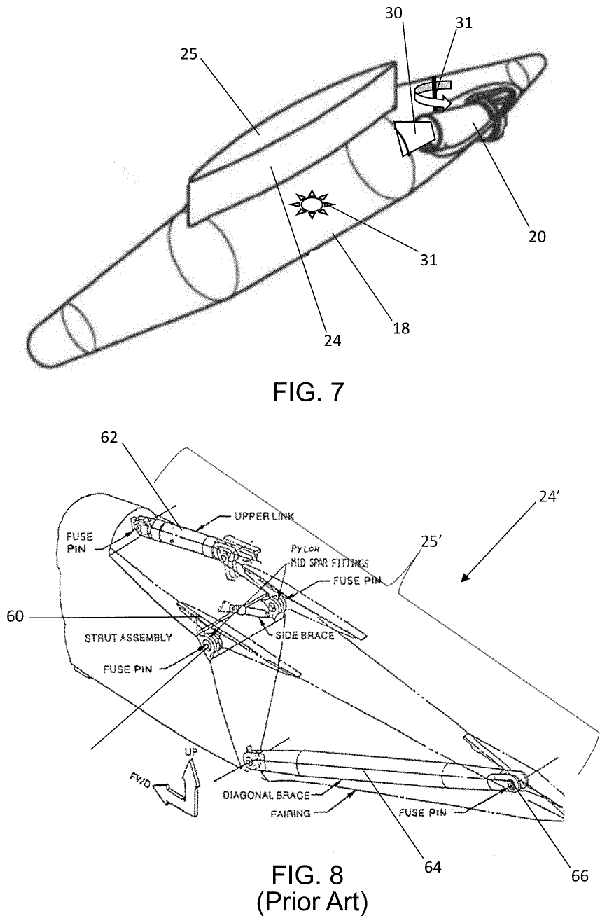

Referring now to the figures, FIG. 1 illustrates an inventive embodiment of an aerial firefighting system (AFS) 10 showing an aircraft 12 outfitted with a conversion kit to a firefighting aircraft. While the aircraft 12 shown is a C-130, it is appreciated that other types of aircraft may be converted to a firefighting aircraft, such as the An-12 and Y-9 and others in the non-exhaustive list. A wing mounted tank 18 with a controllable discharge nozzle 20 is shown under the wing 14 in the vicinity of the engines 16. As best shown in FIG. 7, the nozzle 20 includes a valve 30 that upon opening releases contents of the tank 18 into the atmosphere to then disperse over a target area. As seen in FIG. 3 a main valve 30M controls fluids supplied from the auxiliary tank 26 if the auxiliary tank 26 is present in the system 10. As best seen in FIG. 6 an actuator motor 34 in electrical communication with a switch on a control panel CP (as shown in FIG. 3) under the control of aircraft crew operates the one or more valves 30 and 30M. In some inventive embodiments the actuator motor 34 or several such motors controls operational parameters such as flowrate, nozzle angle, flow pulsing, or a combination thereof. It is appreciated that the sensors 31 associated with a conventional wing tank 18 as to tank volume, ullage, and balancing between disparate wing tanks are all readily utilized in the current invention to maintain the flight trim of the aircraft, and represents another example of retrofit simplicity of the present invention. Sensors 31 as well as other sensors used in embodiments of an aerial firefighting system (AFS) 10 may use wireless links to communicate data in order to avoid the need to run wiring through the fuselage of the plane which is time consuming and may require additional customization to an aircraft.

FIG. 2 shows a rear cargo bay door 22 in a down position and forming a ramp for loading an auxiliary tank 26.

FIG. 3 is an exploded view of the inventive embodiment of the aerial firefighting system (AFS) 10 with the firefighting aircraft 12 of FIG. 1 showing the wing mounted tanks 18 in greater detail, as well as the feed system 28 from the auxiliary tank 26 to the wing mounted tanks 18. The wing mounted tanks 18 are outfitted with a discharge nozzle 20 and are mounted to the wings 14 with the pylon 24. The discharge nozzle 20 in some inventive embodiments includes a valve 30 that also acts as a metering valve to control the flowrate and a pivot 31 (as shown in FIG. 7) to control the direction of dispersal of the fire retardant being dropped.

The pylon 24 may have a quick connect system 25 for attachment and detachment of the tank 18 from an aircraft wing 14. FIG. 8 illustrates a typical existing quick connect system 25′ within a pylon 24′ for mounting an engine, or in the present invention may be configured for securing at least one wing mounted tank 18, to a wing strut assembly 60 utilizing a set of links 62 and braces 64 that are joined to the wing struts 60 with fuse pins 66.

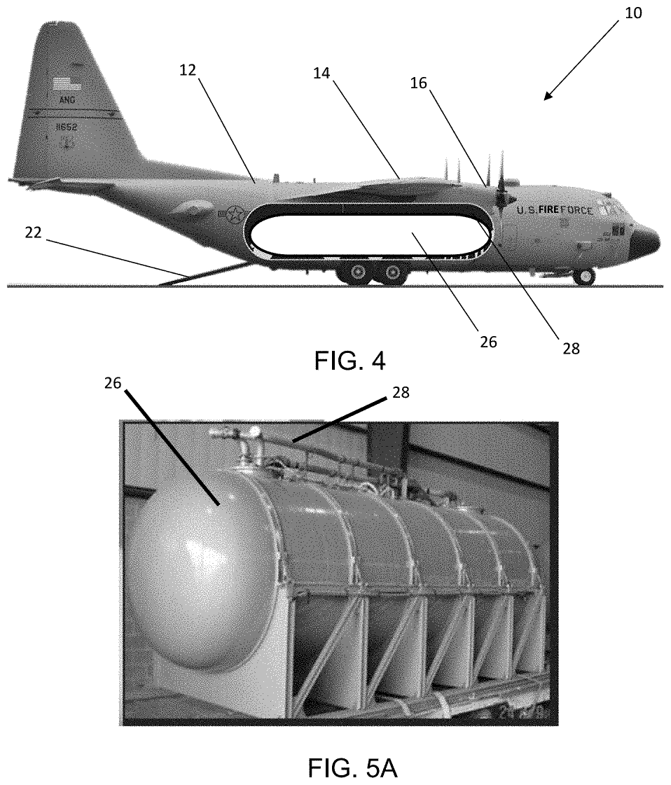

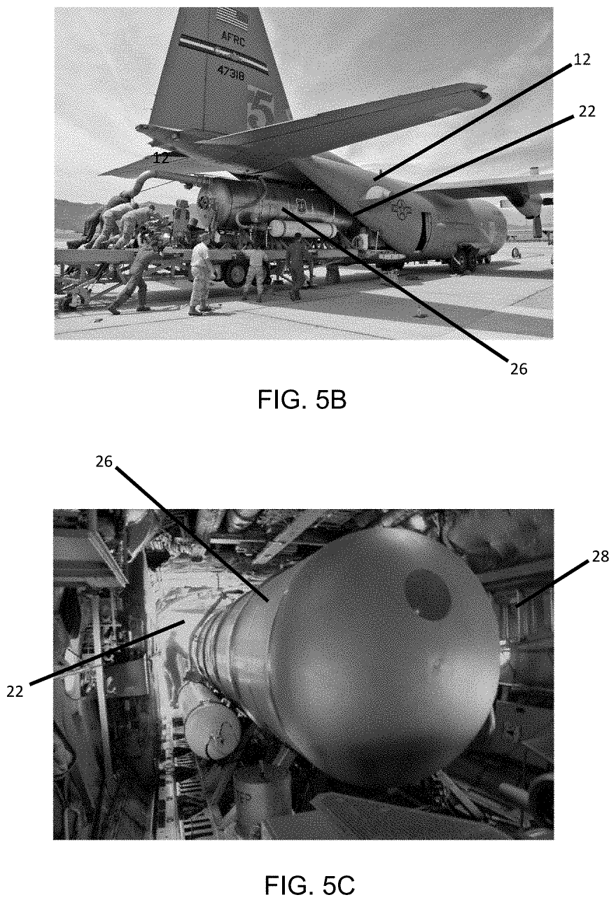

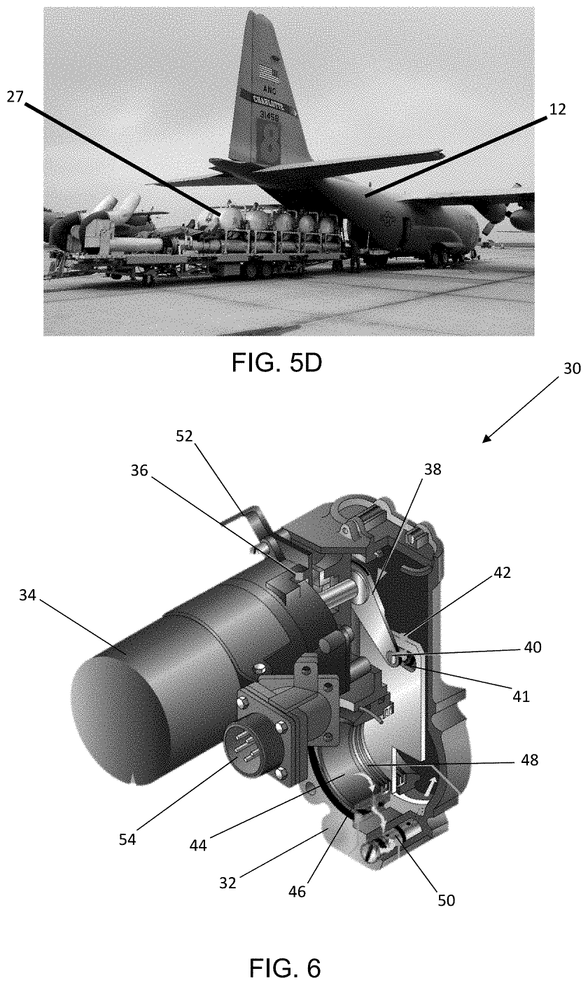

FIG. 4 is a cutaway side view showing the auxiliary tank 26 loaded in the cargo bay 28 of the aircraft 12. The rear cargo bay door 22 is in an open and down position that forms a ramp for loading or removing the auxiliary tank 26. FIG. 5A is a photograph of the auxiliary tank 26 that may be loaded in the cargo bay 28 of the aircraft 12. Also visible in FIG. 5A are a portion of the supply lines of the feed system 28 that distribute the contents of the auxiliary tank 26 to the discharge nozzles 20. FIG. 5B is an exterior photograph showing the loading of the auxiliary tank 26 into the cargo bay 28 of the aircraft 12 with the cargo bay door 22 in an open and down position. FIG. 5C is an interior photograph of the auxiliary tank 26 loaded in the cargo bay 28 of the aircraft 12 with the cargo bay door 22 is in an open and down position. FIG. 5D is a photograph of a multi-cell auxiliary tank 27 being loaded in the cargo bay of the aircraft 12

FIG. 6 is a detail view of an embodiment of a shutoff valve assembly 30 used in the firefighting system 10. The valve assembly 30 has a housing 32 that provides a gated through volume 44 that allows selective passage of a fluid or fire retardant. A motor 34 controls a gear train actuator 36 that actuates an arm with a roller 40. The roller 40 is positioned in a slot 41 of a blade or gate 42 that selectively controls through access in the volume 44. The gate 42 may be totally retracted to allow uninterrupted flow through the volume 44, partially closed to control flow rate, or completely closed to cutoff or stop flow through the valve. An O-ring and seals 48 at a connection point to a supply line or at an inlet to a nozzle provide an air and liquid tight connection. A thermal relief valve 50 and a manual override lever 52 provide operational safety controls. Electrical power and control/sensor signals are provided via connection port 54.

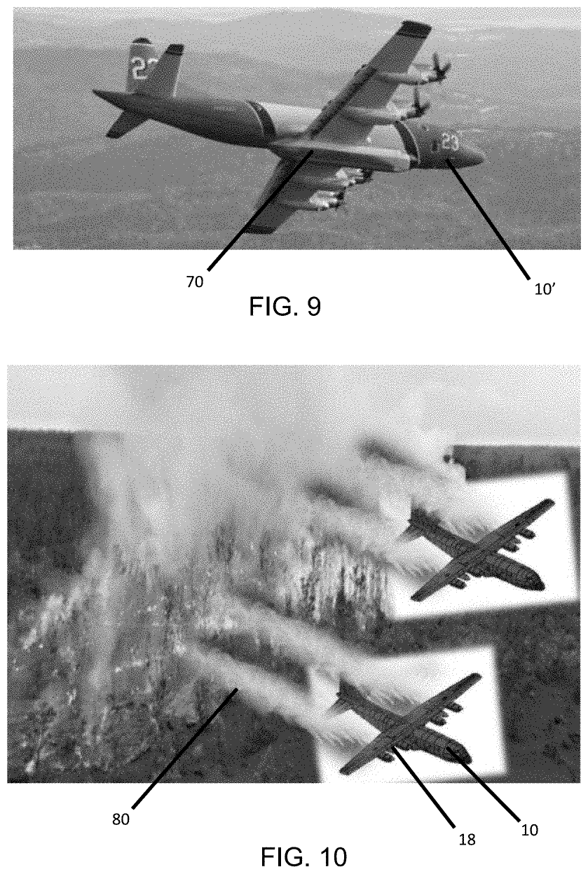

FIG. 9 is a photograph of a belly mounted auxiliary tank or pod 70 as part of an aerial firefighting system (AFS) 10′. In specific embodiments the belly mounted auxiliary tank 60 may be in fluid communication with wing mounted tanks 18, or the belly mounted tanks may have its own discharge nozzle 20.

FIG. 10 illustrates an aerial firefighting system (AFS) 10 of FIG. 1 executing a drop of fire retardant 80 over a forest fire.

A retrofit kit to convert a conventional wing fuel tank for a given aircraft into a tank 18 of the present invention includes a nozzle 20, a valve assembly 30, and a sensor array 31. The valve assembly 30 includes the valve gate 42 and at least one actuator motor 34 therefor. The actuator motor 34 under the control of the flight crew within the aircraft. The sensor array 31 communicating sensor data to the flight crew that includes at least one of flowrate, nozzle angle, or valve pulsing. It is appreciated that by pulsing the valve, the flow rate is dynamic and can illustratively be periodically pulsed or varied over time to create a graded release that in some embodiments is timed to overlap with peak flow timed to release maximal fire retardant onto the fire core, anchor point, of defensible space.

In simplest embodiment, a conventional wing tank is cut with conventional tools and techniques to form an aperture adapted to accommodate a nozzle protruding from the tank, as well as the valve assembly and the sensor array. It is appreciated that tanks that include interior bladders are also readily used herein with the volume of the bladder being in fluid communication with the nozzle. Conventional aerospace adhesives and patch materials are readily applied to restore the fire retardant retention properties to the tank 18 created by the retrofit provided herein.

In some inventive embodiments, piping or flexible tubing is provided to extend between one or more inventive tanks 18 and an auxiliary tank 26 using techniques conventional to equivalent auxiliary fuel tanks.

As a person skilled in the art will recognize from the previous detailed description and from the figures and claims, modifications and changes can be made to the preferred embodiments of the invention without departing from the scope of this invention defined in the following claims.

1. A aerial firefighting system (AFS) comprising:
an aircraft with a fuselage, and a pair of wings extending from each of opposing sides of a fuselage; and
at least one wing mounted tank having an interior volume and attached to at least one of the pair of wings, the volume of said tank adapted to hold a fire retardant dry chemical, fire retardant fluid, or water and comprising a nozzle in fluid communication with the volume.

2. The system of claim 1 wherein said at least one wing mounted tank is a converted range extending fuel wing tank.

3. The system of claim 1 wherein said at least one wing mounted tank further comprises an actuator motor for opening a valve intermediate between the volume and said nozzle.

4. The system of claim 3 said valve regulates at least one of flow rate, nozzle direction, or valve pulsing.

5. The system of claim 1 wherein said at least one wing mounted tank further comprises a pylon with a quick connect system for attachment and detachment of said wing mounted tank from the aircraft wing.

6. The system of claim 1 further comprising an auxiliary tank, said auxiliary tank in fluid communication with the volume of said at least one wing mounted tank.

7. The system of claim 6 wherein the auxiliary tank is held within a cargo hold of the aircraft.

8. The system of claim 7 wherein said auxiliary tank is a palletized tank that can be loaded on to the aircraft as needed.

9. The system of claim 6 wherein said auxiliary tank is mounted to a bottom of said fuselage

10. The system of claim 6 wherein said auxiliary tank has a capacity of 4000-5000 gallons.

11. The system of claim 1 wherein said at least one wing mounted tank further comprises a set of sensors, said set of sensors in wired or wireless communication with a control panel.

12. A kit that coverts an aircraft into an aerial firefighting system (AFS), said kit comprising:
a valve assembly having a housing containing an electric motor selectively driving a gear train actuator operating an arm with a roller, said roller to selectively control through access in the volume, a thermal relief valve and a manual override lever, and a connection port for passing control signals from at least one of said electric motor, said gear train actuator, said arm, said roller, or said thermal relief valve to a fuselage of the aircraft; and
instructions for modifying a fuel tank for the aircraft to contain and selectively release a fire retardant from the volume.

13. The kit of claim 12 wherein said at least one wing mounted tank is a converted range extending fuel tank.

14. The kit of claim 12 wherein said at least one wing mounted tank further comprises a controllable flow nozzle for dispersal of the fire retardant chemical, fluid, or water.

15. The kit of claim 14 said controllable nozzle regulates flow rate and direction of dispersal of the fire retardant chemical, fluid, or water.

16. The kit of claim 12 wherein said at least one wing mounted tank further comprises a pylon with a quick connect system for attachment and detachment of said wing mounted tank from the aircraft wing.

17. The kit of claim 12 further comprising an auxiliary tank held within a cargo hold of the aircraft or mounted to a bottom of the aircraft, said auxiliary tank in fluid communication with said wing mounted tanks.

18. The kit of claim 12 wherein said auxiliary tank is a palletized tank that can be loaded on to the aircraft as needed.

19. The kit of claim 14 wherein said auxiliary tank has a capacity of 4000-5000 gallons.

20. The kit of claim 12 wherein said kit is transportable or shippable to remote areas.
